(19) United States
(12) Patent Application Publication
(10) Pub. No.: US 2020/0020253 A1
(43) Pub. Date: Jan. 16, 2020

(54) PSA Label Rolls using Spent Release Liners and methods and apparatus for making them

(71) Applicant: Kenneth Lin, San MArino, CA (US)

(72) Inventor: Kenneth Lin, San MArino, CA (US)

(21) Appl. No.: 16/483,681

(22) PCT Filed: Jun. 9, 2017
(86) PCT No.: PCT/US2017/036814

§ 371 Date: Aug. 5, 2019

(51) Int. Cl. G09F 3/10; B65C 9/18; G09F 3/02

(52) U.S. Cl. CPC G09F 3/10; B65C 9/1865; G09F 2003/0229; G09F 2003/0226; G09F 2003/0227; G09F 3/02

(57) ABSTRACT

PSA Label Rolls using spent liners and a novel continuous process to convert a stack of face material into a roll of label stock by affixing adhesive coated face material onto a liner. Provides a process to recycle waste liner from conventional roll label stock application machines. Uses an ultra-high solids adhesive that needs no drying. Roll label stock made by such a process provides large cost savings and beneficial environmental impact.

### CROSS-REFERENCES TO RELATED APPLICATIONS

This application claims the benefit of U.S. Provisional Patent 62/456,660 filed on Feb. 9, 2017 which is incorporated by reference herein.

### BACKGROUND

Pressure Sensitive Adhesive (PSA) labels are ubiquitously used in commerce. PSA labels can be roll labels, sheet labels or even stacked labels. Large roll label stock is supplied to a label converter by a label stock manufacturer. A label converter prints, strips and slits the label stock roll to make label rolls, label sheets or label stacks. A label applicator usually applies individual labels to packaging substrates.

Of the three formats of label described above, by far the biggest chunk in labels is in the roll label format. Roll labels process faster in printing and application machinery. Roll labels wastes fewer labels because of better applicator precision resulting in no-throwaway labels. Roll labels offer more variety in materials.

A label applicator's PSA labeling machine applies the label from a PSA label roll onto the substrate that needs the label. The operation generally entails dispensing the individual label from the roll and laminating the label to a package substrate. This is usually done at high speeds.

A major cost component of a label is the carrier or the release liner used in a label roll. The liner functions as a carrier for the handling and the delivery of the adhesive-coated label in both the manufacturing and the application processes. The liner is considered as necessary waste. It is essential for the production and application of labels. Many PSA label cost reduction efforts are centered around reducing component material cost. In the case of the liner, recycling of the liner has been proposed earlier.

Most of the converting industry today discards the liner as waste which goes into landfills. Some collect the liner materials for recycling. The recycling process involves re-pulping of the coated liner to reconstitute into virgin paper. However, this is made difficult by the presence of release coatings such as silicone that tend to clog up the repulping/recycling machinery. Liners by themselves are not re-used for many practical reasons described below. There is a great need in the industry to develop methods of liner re-use in labeling applications.

A roll label user typically uses PSA roll labels in narrow web format, typically 2-4 inch wide webs, typically one label width. This is the preferred format that the label converter supplies to the roll label user. A corresponding liner removed from such rolls is too narrow for a label converter to economically re-coat with an adhesive. Complex adhesive coating operations are done cost effectively in wide web formats by stock roll producers with precision coating methods, and drying equipment. Tight coat weight control is needed to ensure that every square inch of the large web is usable when cut into little labels. Coating narrow liner webs is an expensive operation due to lack of scale. As a result, there is no motivation for the stock label material coater/dryer to precision coat expensively on such narrow liners.

Additionally, the adhesives available for adhesive coating to be done at a label applicator's site using a glue machine are limited. Current glues and hot melts used today are for non-PSA adhesives and the operations are very messy and cumbersome. The process of making the labels is usually a just-in-time process as glued labels cannot be stored for use later by the applicator. A label applicator would greatly welcome applying labels using lower cost PSA label rolls from a label converter as opposed gluing labels in line themselves.

However for a label converter, PSAs with large solvent or water fractions are expensive to dry. There is a great need for a PSA adhesive that does not need an active drying step to improve the practicability of the operation. Such an adhesive would allow a label converter to do coating of adhesives on narrow webs.

Additionally, specialty label converters often handle small quantities of labels in batches. As a result, face-materials (alternatively called facestock) for specialty labels are produced in narrow web formats. Once again, cumbersome coating and drying operations are impractical for small lots.

The supply chain described in FIG. 1 complicates the re-use of liners as well. The traditional applicator simply discards the waste liner. In the industry these are compartmentalized activities Whose division is based on operating efficiency/speeds of each of the processes in the manufacturing chain. Any solution in re-use needs to bring worthwhile economies for any label converter to be motivated in re-use of liners. i.e. it has to offer significant worthwhile cost savings to the label converter.

For re-use the discarded liners will need to be picked up by the label converter and reconverted into a label roll for use by the applicator. In other words, there is a great need for waste liner to be “filled” with new facestock and adhesive in a cost-effective manner. The descriptors “filled” and “refilled” will be synonymously used in this specification.

The issues described above drive a severe need on the part of a label applicator for a novel low cost (from a supply chain perspective) facestock/adhesive and a convenient process to refill the facestock/adhesive onto used liners.

Large quantities of narrow web liners that are wasted today and there is an increasing need to demonstrate utility in any novel economic re-use solution. Recycling solutions today are centered around repulping the liners.

There is a real need to “re-fill” the adhesive/facestock” on the used liner and put the liner back in use. However, the adhesive cannot be easily economically coated onto the liner as easily with current practices. One faces a dilemma and the solution can only be implemented with a novel process that allows the liner to be used without all the economic burdens (limitations in drying, direct coating of facestock) of a traditional coating process.

There is a need for a process to perform this re-filling of expensive liner to reduce effective product cost.

Thus there a need to develop an economic adhesive coating process for the narrow web labels liners.

Thus there is a need to use adhesives that do not need active drying.

### SUMMARY OF THE INVENTION

The invention relates to a process of reuse of a release liner. A spent label roll from a label application process is used to make new label rolls. In any label application process the labels are removed off the roll label liner and applied to a substrate. The liner at the end of the process is rolled up and typically wasted. We call this wasted liner a ‘spent’ liner’. It also referred to as a spent roll or a spent label roll.

In one aspect the invention is a process to make new label rolls using a release liner from a spent label roll from a labeling application process by affixing new labels onto the used release liner.

In yet another aspect the invention is a process to make new low cost label rolls.

In yet another aspect the invention is in the use of an adhesive, which does not require precision coating or complex drying processes, to affix the new labels onto the new or used release liner.

In yet another aspect of the invention is in the re-arrangement of the supply chain around the label converter for the converter to cost effectively replace new label rolls with cheaper label rolls that use spent liners.

In yet another aspect the invention is a process to convert a stack of label face materials into a label roll for use in the label application process.

### DRAWINGS

FIG. 1 graphically shows the industry's current supply chain in label processing.

FIG. 2 graphically shows the new Label Converter centric supply chain using the refilling process.

FIG. 3 shows one embodiment of the refilling process.

FIG. 4 shows a perspective an embodiment of FIG. 3.

FIG. 5 shows another embodiment of the refilling process.

FIG. 6 shows a perspective an embodiment of FIG. 5.

FIG. 7 shows equipment arrangement of Example 1.

### DETAILED DESCRIPTION OF THE INVENTION

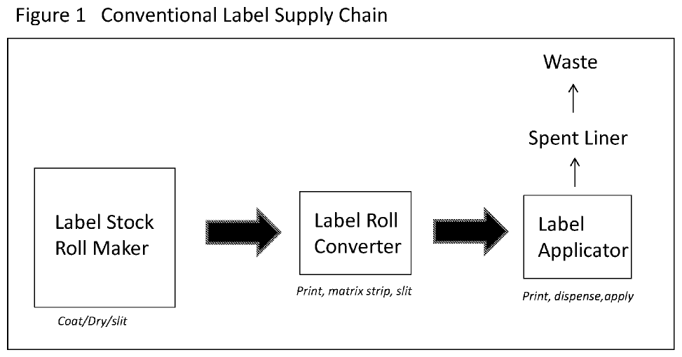

FIG. 1 shows the labeling industry's conventional supply chain. A label stock maker provides large width label stock rolls to a label converter who makes narrower label rolls from them. A printing step may be included by the label converter. The label roll then is used by a label applicator who applies the labels to packaging in an assembly line fashion. After the label roll is used up the spent release liner is disposed of. The spent liner is usually discarded if recycling is cumbersome. There is no re-use of liners in the label processing industry today. The release liner constitutes a very large portion of the total cost of PSA labels.

What is proposed in this invention is a method to re-use each spent liner up to at least 20 times by the label converter. We anticipate that each spent release liner can be re-used as much as 50 times.

Such re-use is economically very attractive to the label converter who can cut back on his new label stock roll supply.

We envisage a smooth operation whereby the spent liner from one labeling machine run at a label applicator could be “refilled” by a label converter for use in another labeling applicator machine run. The liner would be refilled with a blank or printed face material and an adhesive.

The refilled adhesive used should be such that its coating does not present issues to the label converter. Precision adhesive coating and drying require complex machinery and is usually done on wide web formats to scale costs. Label rolls are narrow format and the precision coating and drying process is very cumbersome and expensive to be easily applied to narrow formats. For these reasons, the adhesive selected by a label converter should be a hot-melt (encompassing no drying) or preferably a UHS (ultrahigh solids emulsion needing no active drying) adhesive and its coating process on the face materials needs to be simple.

Large stock roll makers use precision coating machinery and complex drying equipment so that every square inch of the adhesive coating would be finally usable when the rolls are slit down for labeling use. On the other hand at a label converter, such precision coating is not needed because labels do not require 100% area coverage in adhesive coating for them to meet label applicator demands. One can dispense with precision coat complexities.

The adhesive coating in these processes does not need to be a precision coat. In fact some labels do not even need a continuous coat of adhesive. Variation in coat weight is not critical to label performance. Savings in adhesive can also be achieved through pattern coating of the adhesive. The complexity of coating is greatly reduced by using either hot melt or UHS adhesives. No drying is needed.

The use of solvents and traditional emulsions at the large scale requires complex drying ovens with very sophisticated web paths to dry at high speeds at scale. Label converters need simpler processes. The use of adhesives that do not require active drying such as hot melts or UHS adhesives can eliminate the need for complex drying equipment.

Some label converters die-cut the face stock of the roll labels in making of the labels rolls. This can damage the release coating on the liner so that they cannot be effectively re-used. With our inventive process the need for die-cutting will be eliminated as the label converter can use stack label facestock in the refilling process and the need to die cut to shape the label face is eliminated.

All of these changes would result in significant savings to the label converter.

A typical roll label today costs between 5 and 30 cents. The processing costs of coating/drying and the costs of the disposed release liner contribute in a major way to the cost of the label. On the other hand, an uncoated stacked facestock label, a cut and stack material, can run from 0.5 to 2 cents. There is considerable economic opportunity in refilling the spent roll liners with new cut and stack label material and a new adhesive to make a new label roll.

We propose to take a new stack of face materials, coat a new adhesive to the label, laminate the coated labels to the spent liner and thereby convert the spent liner into roll label rolls for use by labeling machines. We refer to this operation as “refilling” the spent liner.

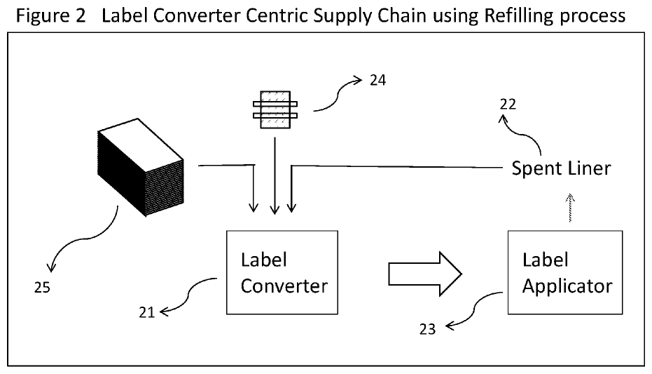

A new configuration of the supply chain is expected to emerge upon the commercial practice of this “refilling” solution shown in FIG. 2. The Label Converter 21 now uses the spent liner 22 sent back by the Label Applicator 23, a fast drying adhesive 24, which could be a high solids emulsion adhesive (a UHS adhesive) or a hot melt (with no drying), and printed stacked label facestock 25. The role of the stock label provider would decrease and the economic advantages to the label converter would increase.

Currently the label stock producer sells large rolls to the label converter. The label converter produces narrow label rolls. The label rolls are then sold to a label applicator who applies the labels onto packaging such as bottles. The label applicator discards the spent release liners.

The spent release liners from the label applicator would in this inventive process be picked back up from the label applicator by a label converter and refilled into a label roll and supplied for subsequent use to the label applicator. The applicator would not need to dispose the spent release liner anymore. With this process, the label converter could potentially cut his use of expensive virgin roll label stock significantly. At any one point in time, the label converter would have a mix of virgin and filled roll label inventory, their ratio being dependent upon the number of refilling cycles each spent liner can undergo.

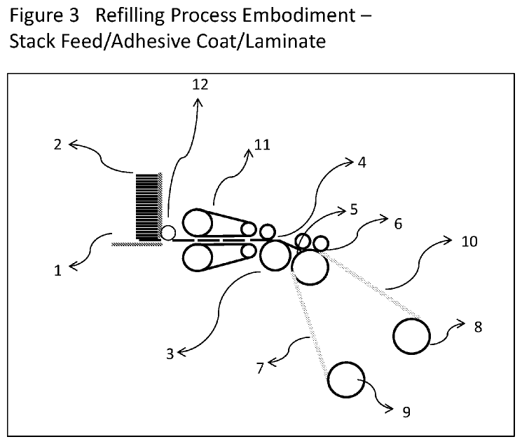

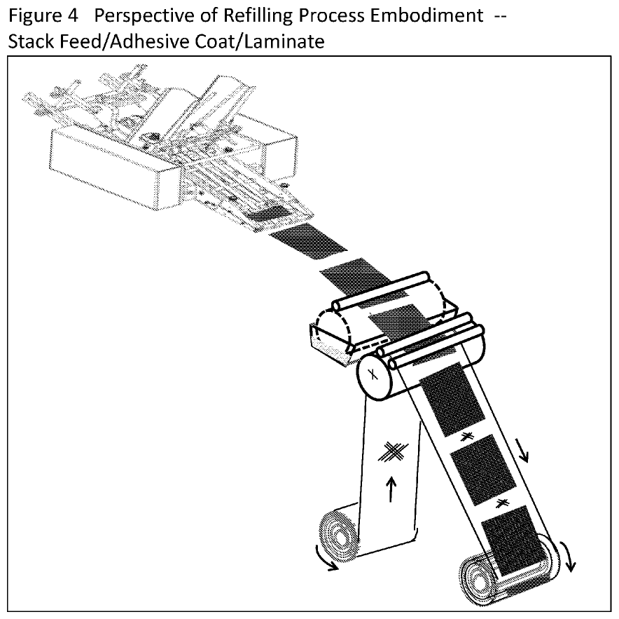

In one embodiment shown in FIG. 3 and FIG. 4, the stack face materials would have a PSA adhesive applied to them by a gluing machine and the coated labels would be dispensed and laminated onto a used release liner to make a PSA label roll. The PSA label roll then would be used in a label applicator machine. The spent liner from the label applicator operation would then again be sent back to be laminated with more glued labels from the gluing machine. This process can repeat indefinitely until the spent liner is completely unusable.

FIG. 3 shows an embodiment of the refilling process. This embodiment of our process is referred to as Stack feed/Adhesive coat/Laminate. A stack dispensing machine such a friction feeder 1 feeds the face material from a face material stack 2 one label face at a time to an adhesive coating station such as a gluing machine 3. The face material can be a printed material in a Cut and Stack format. The gluing machine picks up the individual label face in its nip 4, applies the adhesive and sends the coated label face into the nip 5 where the label face is laminated with laminating roll 6 onto a spent liner 7 unwound from a spent liner roll 9. The refilled liner 10 is rewound after the label is affixed to it to make a finished label roll 8. FIG. 4 shows a perspective of this process.

The adhesive coating processes employed can be the full range of traditional coating process in the art such as knife over roll coating, die coating, gravure coating, extrusion coating, spray, brush, or print. The simpler the coating process, the more cost effective the solution. Hot melts need to be coated at high temperatures and hence while they can be used, UHS adhesives coated at room temperature are preferable. The higher viscosities of UHS adhesives may require nip feeding of the adhesive.

Many varieties of friction feeders are available. They have guiding mechanisms 11 and 12 to dispense and transport each individual face label to the next station.

The face sheet dispensing should not be limited to stack dispensing. A perforated roll of face material that can break away individual face material will also do. Any process that can deliver one label face to an adhesive coating station is envisioned. There are a large number of mechanical devices that can do this job and all are intended to be covered within the scope of this invention.

The process of lamination of the coated face label onto the release liner is a critical step. In a glue machine, the coated labels are released from the coating roll by the striping finger and pressed downward by the non-touching pressure roller. With the right nip pressures at the gluing machine and proper guided direction in entering the nip, the nip can grab the individual coated label from the output of the gluing machine. Proper lamination to the release side of the spent liner can be done using multiple roller arrangement if necessary.

In some cases, the spent release liner may be contaminated with adhesive or other materials release coating side of the spent liner will have to be cleaned in-line as it is unwound before affixing the face materials. Additionally adhesive ooze, poor face material placement may require a cleaning step after the label is affixed. Proper setting of process parameters and material design parameters can eliminate the need for these actions in the inventive process.

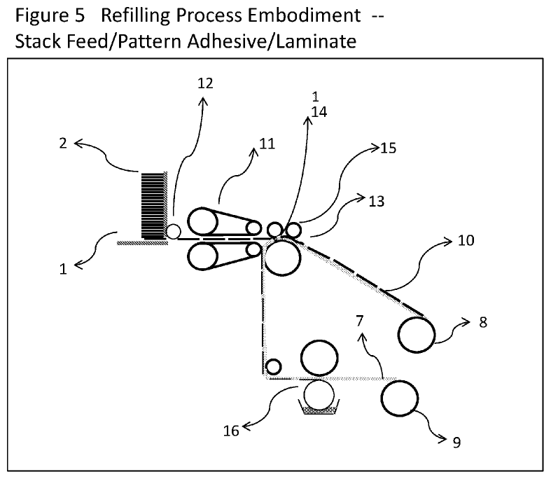

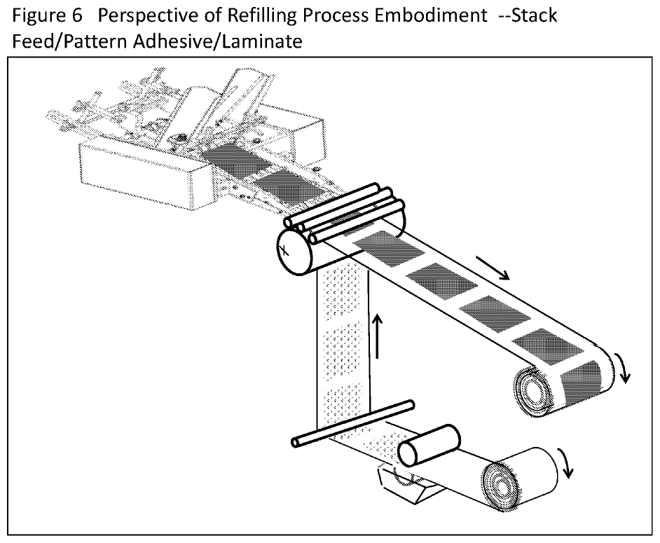

In yet another embodiment shown in FIG. 5 and FIG. 6, the PSA adhesive could be pattern coated onto the release surface of a used liner and face materials from a label stack could be dispensed, registered and laminated to the patterned adhesive on the spent release liner such that the labels land right on top of the patterned adhesive. The spent liner would then be rolled up to provide the new label roll.

FIG. 5 shows a yet another embodiment of the refilling process. This embodiment of our process is referred to as Stack feed/Pattern Adhesive/Laminate. A stack dispensing machine such a friction feeder 1 feeds the face material from a face material stack 2 one label face at a time to laminating machine 13. The laminating machine picks up the individual label face in its nip 14, applies a cut label onto a printed adhesive area on a web that is registered to match and receive the label, and the label face is laminated with laminating roll 15 onto a spent liner 7 unwound from a spent liner roll 9. Prior to the laminating machine the spent web has an adhesive pattern printed on its release coated side at an adhesive coating station 16. The refilled liner 10 is rewound after the label is affixed to it to make a finished label roll 8. FIG. 4 shows a perspective of this process.

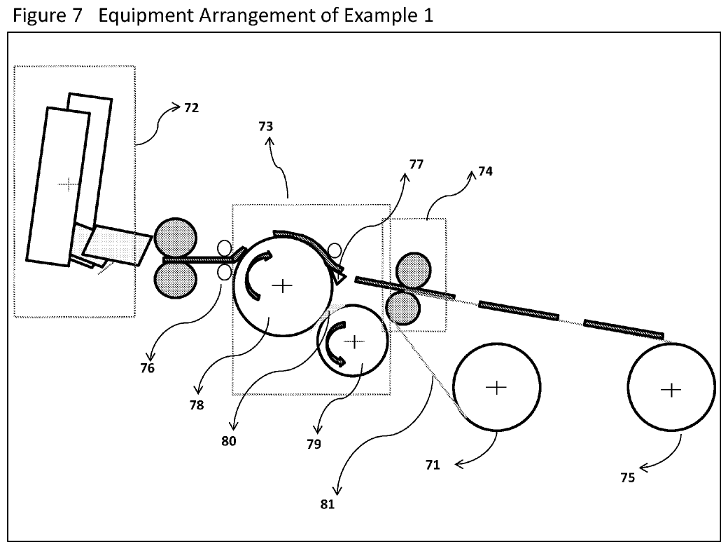

A gluing machine is a cost effective way to get consistent good labeling results with a room temperature based adhesive. It applies adhesive to labels and is simple to operate. Excellent adhesive control with low maintenance makes it particularly economical. They have guiding arms that enable a coated label to be fed into another machine for further processing. However gluing machines handle relatively low viscosity adhesive. Our invention prefers to use higher viscosity adhesive such as UHS adhesives or hot melts because we want to keep the drying load to be zero with no need for a dryer. This may require modifying the current available machines to properly coat the adhesive onto the label face material. A nip fed roll coating can accommodate higher viscosities and such a modification could be readily applied to a standard gluing machine. Such an embodiment is shown in FIG. 7. This embodiment shows the use of stripper fingers to move the coated label off the coating roll onto the release liner.

The adhesive coating station can be of several types using the traditional coating processes in the industry such as gravure, roller, hot melt coatings, brush, and spray. Any coating method that can pattern print a UHS adhesive or a hot melt adhesive onto the release liner is intended to be included.

The term adhesive and glue have been used interchangeably in this specification.

UHS adhesive when completely dry become completely transparent. Clear film labels are a very high value added segment. Labels used in this process with UHS adhesives can also be clear film label face materials.

“Cut and stack” or stacked labels refer label face materials assembled in a stack similar to deck of cards. They are usually pre-printed.

Registering is a control method by which the precise placement location of a label is determined in a continuously moving web and the label is placed in the target spot by the dispensing and laminating machinery. Proper registration will be required for all label placements onto the spent liner.

The term ‘spent’ liner is synonymous with used liner. The liner is spent after the applicator has applied the labels from the label roll. The liner at the end of application without any labels on it is the spent liner.

Most label converters use a die-cutting process to make labels from label stock. Label stock is the face-adhesive liner sandwich. The die cuts the face material and goes through the adhesive layer but does not cut through the liner. The liner surface often gets cut up in the process. This damage is often referred to as die marks.

A UHS adhesive is a ultra-high solids emulsion adhesive with solid content of greater than 65%. See U.S. Pat. No. 8,729,157 to Lin for full description of adhesive. Such an adhesive does not have much of a drying load.

The term label, sticker, cut label are synonymous. Stickers can also be made by our inventive process.

Using a high solid emulsion such as a UHS adhesive is better than using hot-melts in labels. Label makers and applicators tend to prefer high solid emulsions over hot-melts because there is no need to heat the adhesive in processing, emulsion line is much easier to operate than a hot-melt line, and the process equipment is much easier to clean. UHS emulsions do not strike through the face material when coated directly and thus have a much better stain resistance.

We have outlined a novel method to convert inexpensive cut and stack labels into value added PSA roll labels with an easy and economical process. The process leads to the re-use of release liner for making value added PSA roll labels.

It would be obvious that one can conduct our inventive process using virgin liners too.

Among the major benefits are the dramatic reduction in production cost for making PSA roll labels and the saving of environmental resources that go into the making of the disposed silicone coated release liners. Additionally we save a large amount of energy used up in the making of making large PSA stock rolls.

The enabling technologies that we have developed are 1) a novel PSA roll label production process whose elements have been outlined in the description above 2) preferably using UHS emulsion PSA per U.S. Pat. No. 8,729,157 to Kenneth Lin, incorporated by reference herein, and 3) An efficient release liner recycling program.

The refilling concept proposed is a novel concept not used by anyone in the label converting industry today. There exists no configured process to achieve this. The industry does not re-use once-used roll label liners today. Once-used liners are also called recycled liners or spent liners.

The essential elements of the refilling process are 1) the dispensing of the cut and stack face label, the application of the adhesive, either directly to the label or indirectly to the spent release liner and the lamination of the label are individually known processes with lots of options in processing methods What is inventive here is the novel combination for the purpose of refilling of the spent liner. There will be further optimization work that needs to be done to make these three components work together to achieve high processing speeds for different kinds of labels. It is likely that the equipment is each of the process steps will need to be customized to process unique varieties of label materials.

Our inventive process and product is commercially mainly directed to roll-to-roll processing. It is obvious that the same process can be practiced manually to accomplish a similar result. One can manually coat a single label facestock or liner sheet with a UHS adhesive and then laminate it with a release liner or a facestock respectively to make a facestock/adhesive/liner sandwich. Such obvious extensions are considered to be covered by the scope of our current invention.

### Example 1

Label stock rolls were made using the process described in FIG. 3.

A continuous line was assembled as shown in FIG. 7. A release liner unwinder station 71, a precision stack feeder 72, an adhesive coater 73, a laminator 74 with non-stick rollers and a roll re-winder station 75 are placed in the arrangement shown. Grabbing nips are created at appropriate locations to properly handle the individual labels and the web.

Pinch rollers 76 were used to grab individual labels. Distances between the feeder discharge end and adhesive entry nips was adjusted to ensure that a single label pathway is controllable with the nips provided. Stripper fingers 77 were used at the discharge end of the coating station to detach the coated label from the coating roll 78. A metering roll 79 was used to deliver UHS adhesive 80 to the coating roll. The adhesive was filled in the nip reservoir manually.

A stack of preprinted paper label face-material (3″ by 7″, Blue color, “Table Tennis Rubber Cleaner”) was placed in the stack feeder at one end. A 4 inch wide release liner (medium release, 70 lb. Supercalendered Kraft Paper) on a 3″ core was mounted on an unwind station and was threaded in the web path shown in FIG. 7. The liner was set up to unwind and was wound continuously onto the core of the re-winding station.

The liner 81 went through the laminator nip where the adhesive coated label was affixed on the release surface of the liner. Simultaneously an adhesive coating station was operated to feed the individual adhesive-coated label serially into this laminating nip. The moving liner was subsequently wound up into a roll at the re-winding station. The adhesive coating station was fed with individual preprinted rectangular “Table Tennis Rubber Cleaner” label from a stack friction feeder. The coated labels from the coating station were handled by stripper fingers across the web width so as to maintain a continuous steady feed onto the release surface of the liner. Adequate web control was provided so that the moving web stayed properly aligned in the web direction.

The liner speed was set to 0.7 feet/second and the coated labels were fed onto the liner at about 45 labels per minute. The friction feeder speed was to maintain a dispensing rate of 45 labels per minute.

A finished roll of label roll stock was removed from the unwind station. This roll was of good quality and could now be subsequently used in a label applicator machine.

We claim:

1. A continuous method to make a PSA label roll with spent release liner comprising
procuring a spent liner roll from a converter waste stream,
unwinding the roll of spent release liner,
dispensing an in-line adhesive-coated label facestock onto the release surface of the unwound liner,
laminating the adhesive coated label together with the liner, and
re-winding the liner into a new PSA label roll.

2. (canceled)

3. The method of claim 1 where the adhesive has an adhesive solids content greater than 65%.

4. The method of claim 1 where the label is a clear film.

5. The method of claim 1 wherein the label is in-line adhesive-coated in a gluing machine.

6. The method of claim 5 where the glue machine is stack-fed with label face-material.

7. The method of claim 6 where the stack feeding process is accomplished by a friction feeder.

8. A low cost PSA label comprising
a cut label facestock,
a high solids emulsion adhesive, and
a spent release liner.

9. A roll of labels of claim 8.

10. The low cost PSA label roll of claim 8 where the liner is recycled at least once.

11. The low cost PSA label roll of claim 8 where in the release surface of the said release liner has never been subjected to any die-cutting.

12. A spent liner with no die cut marks.

13. A method to make a PSA label roll with spent release liner comprising
procuring a spent liner roll from a converter waste stream,
unwinding the release liner roll,
pattern-coating an adhesive, preferably a UHS emulsion adhesive, on the release surface of the unwound liner,
dispensing a label onto the pattern coated adhesive on the release liner,
laminating the dispensed label onto the release surface of the liner,
optionally removing excessive adhesive from the liner or transferring the adhesive-coated label onto another liner, and
re-winding the liner into a new PSA label roll.

14. (canceled)

15. The method of claim 13 wherein the adhesive solids content is greater than 65%.

16. The method of claim 13 where the label is a clear film.

17. The method of claim 13 wherein the label is sheet-fed or stack-fed.

18. (canceled)

19. A apparatus to fill spent liners with labels to make a PSA label roll using spent liners comprising
an unwinder to feed a spent liner,
a feeder to dispense individual labels,
an adhesive coater to adhesive coat the fed labels, or alternatively adhesive pattern-coat the liner,
a laminator to affix the labels to the spent liner, and
a winder to roll up the finished PSA label roll.

20. (canceled)

21. The apparatus of claim 19 wherein the adhesive is an emulsion adhesive with solids content greater than 65%.

22. The apparatus of claim 19 where the label is a clear film.

23. A process to make a roll of labels with spent liners without the use of any drying equipment.

24. A process to recycle spent liners by using them in new label rolls.
